(19) United States
(12) Patent Application Publication
(10) Pub. No.: US 2002/0075272 A1
(43) Pub. Date: Jun. 20, 2002

(54) Display control device and mobile electronic apparatus

(75) Inventors: Kunihiko Tani, Kodaira (JP); Yoshikazu Yokota, Kodaira (JP); Goro Sakamaki, Fuchu (JP); Takashi Ohyama, Tokyo (JP)

Correspondence Address: MILES & STOCKBRIDGE PC, 1751 PINNACLE DRIVE, SUITE 500, MCLEAN, VA, 22102-3833, US

(73) Assignee: Hitachi, Ltd.

(21) Appl. No.: 09/998,325

(22) Filed: Dec. 3, 2001

(30) Foreign Application Priority Data
Dec. 18, 2000 (JP) 2000-383012

(51) Int. Cl. G09G 5/39

(52) U.S. Cl. 345/531

(57) ABSTRACT

The display RAM built into a conventional display control device uses a system in which data are sequentially written word by word, it involves a problem that, if th write speed is to be raised to match the transfer speed of display data from the microprocessor, the power consumption will increase in proportion to the transfer speed. The width (number of bits) of write data to a display RAM in a display control device is set to be an integral multiple of the width of write data supplied from an external microprocessor or the like, and two stages of latch circuits for holding write data equivalent to one row of the display RAM are provided. A few cycles' equivalent of the write data supplied from the microprocessor or the like is taken into the first stage of latch circuits and, when the data are ready, they are collectively transferred to the second stage of latch circuits, so that the data held by the second stage of latch circuits can be collectively transferred by a transfer gate to the display RAM for displaying.

### BACKGROUND OF THE INVENTION

The present invention relates to a display control device for controlling displays on a display unit in which a plurality of display segments are two-dimensionally arranged (e.g. a dot matrix type display unit) and further to a technique effectively applicable to a write data latch circuit of a memory for storing display data in the display control device, for instance a technique effectively applicable to a liquid crystal display control device and a mobile electronic apparatus therewith.

Today, as a display device for a mobile electronic apparatus such as a mobile telephone or a pager, a dot matrix type liquid crystal panel in which a plurality of display picture elements are two-dimensionally arranged in a matrix form, for instance, is usually employed. In such an apparatus, a display control device, configured as a semiconductor integrated circuit, a driver for the liquid crystal panel or a display control device with a built-in driver is mounted for controlling displays on this liquid crystal panel. Some of these display control devices may have a rewritable random access memory (RAM) built into it for storing data to be displayed on the liquid crystal panel. Upon receiving data displaying from a microprocessor controlling the whole apparatus or processing transmit/receive signals, the display control device rewrites display data in the internal RAM (hereinafter to be referred to as the display RAM).

More specifically, as shown in FIG. 11, data such as 1 word (16 bits), supplied from the microprocessor via buses BUS0 through BUS15 are successively taken into latch circuit groups LTG1 through LTG4, provided to match bit lines of the display RAM 140, in synchronism with timing signals φ11, φ12 . . . shown in FIG. 12. Transfer gate groups TGT1 through TGT4, provided between the latch circuit groups LTG1 through LTG4 and the display RAM, are successively opened in accordance timing signals φ31, φ32 . . . , and data are successively written into the display RAM 140 word by word. This has been the usual way or processing.

### SUMMARY OF THE INVENTION

Previously, many of the liquid crystal panels used in such mobile electronic apparatuses were for monochromic displaying. However, along with the increasing functional sophistication of mobile electronic apparatuses in recent years, contents to be displayed on the display unit are increasing in diversity, with color displays or animated displays beginning to be available.

Since color displays or animated displays involve far greater quantities of display data than monochromic still picture displays, the microprocessor needs a high operating frequency, and the display RAM is also required to perform high speed write operations.

However, among mobile electronic apparatuses, since mobile telephones in particular need battery saving, the display control device and other LSIs to be mounted on them are required to be reduced in power consumption. Yet, as the display RAM built into a conventional display control device uses a system in which data are sequentially written word by word as shown in FIG. 12, a problem has been found that, if th write speed is to be raised to match the transfer speed of display data from the microprocessor, the power consumption will increase in proportion to the transfer speed.

An object of the present invention, attempted in view of the problem noted above, is to provide a display control device capable of writing data into an internal display RAM at high speed without increasing power consumption and a mobile electronic apparatus mounted therewith.

The above-stated and other objects and novel features of the invention will become apparent from the description in this specification and the accompanying drawings.

What follows is a brief summary of a typical aspect of the present invention disclosed in this application. Thus, a display control device provided with a display memory which is capable of storing display data for a display device and into which display data are written in a prescribed number of bits at a time, the display control device successively reading display data out of the display memory and forming and supplying a drive signal to the display device, wherein the display memory has a memory array provided with a plurality of memory cells arranged, well ordered in vertical and horizontal directions, a plurality of word lines to which selection terminals for the memory cells of the same row are connected, and a plurality of bit lines which are arranged in a direction to cross the word lines and to which data input/output nodes for memory cells of the same column are connected; input transfer means and output transfer means are connected to the bit lines; data transferring by the input transfer means results in writing of data into memory cells connected to a word line in a selected state; and data transferring by the output transfer means results in reading of data out of memory cells connected to a word line in a selected state, further provided with a plurality of first data latch means capable of successively taking in display data in the prescribed number of bits at a time, and display data held by the first data latch means can be collectively transferred by the input transfer means to the bit lines of the display memory in a number of bits at a time equal to an integral multiple of (n times) the number of bits of the display data taken into the first data latch means.

The device described above, in which the display memory has a configuration without sense amplifier, namely a configuration in which data to be written into the display memory are transferred by the input transfer means from the latch circuit directly to a bit line and, when data are to be read, data on a bit line are supplied by the output transfer means and a plurality of data are collectively written into the display memory are being once latched by the latch circuit, can save power consumption as much as a sense amplifier would otherwise consume, and the power consumption by the memory can also be reduced compared with a system in which data are written one by one into the display memory because the frequency of accessing the display memory (the frequency of actuating word lines) is reduced. The dispensation with a sense amplifier, even though it may slow down writing or reading, results in faster overall data writing than the conventional system of writing data one by one because a plurality of data can be written into the display memory collectively.

Preferably, the display control device may be further provided with a plurality of second data latch means capable of taking in display data held by the first data latch means in a number of bits at a time equal to an integral multiple of the number of bits of the display data taken into the first data latch means, wherein the input transfer means are configured to be capable of transferring display data held by the second data latch means to the bit lines of the display memory in a number of bits at a time equal to an integral multiple of (n times) the number of bits of the display data taken into the first data latch means. As this enables, while the data to be written into the display memory are transferred from the second data latch means to the display memory, the display data to be written next to be taken in by the first data latch means, data can be written at high speed even when writing of data into memory cells connected to the same bit line is to take place consecutively.

Also preferably, transferring of data by the input transfer means to the bit lines of the display memory may take place at the same timing as the final data are taken into the first data latch means. This enables, even when data to be written into the display memory are to be transferred in a number of bits at a time equal to an integral multiple of the prescribed number of bits, the data can be transferred one cycle earlier than where they are transferred to the display memory collectively in the next cycle after the final data are taken into the first data latch means.

Also, the number of the first data latch means is an integral multiple further of the n times. This enables, where data are to be written consecutively onto one row of the display memory, the data can be transferred without generating any fraction and the total time length of data writing to be shortened.

Further, the display control device may be further provided with a mask setting means capable of setting the number of bits of data to be transferred by the input transfer means to the bit lines of the display memory, with the input transfer means being controlled on the basis of the set information of the mask setting means. This enables, even where data are to be rewritten by collective writing from any position in the display memory, data not required to be rewritten to be prevented from being rewritten by mistake. Also, where data are to be written from midway in a plurality of collectively rewritable data, the use of the mask setting means makes possible collective writing and a reduction of the time length required for writing.

The mask setting means may be configured to be able to set the start address of write data in a range of consecutive addresses and the quantity of data to be masked from that start address and the end address of the same and the quantity of data to be masked from that end address. This makes possible masked writing of data of any length with the mask setting means.

Further, the display control device may be provided with a segment drive means for generating signals for driving segment electrodes of an external liquid crystal display device on the basis of display data read out of the display memory, the means being configured as a semiconductor integrated circuit over a single semiconductor chip. This makes it possible, where a system using a liquid crystal display device is to be configured, the number of components constituting the system, and accordingly the mounting area, can be reduced because the segment drive means is built into the display control device.

A mobile electronic apparatus pertaining to the present invention is provided with a display control device having any of the configurations described above, a data processing unit for generating display data to be written into the display memory and setting information on their writing position, and a display device for carrying out displaying with a display drive signal read out of the display memory and formed by the display control device on the basis of the display data. This serves to reduce the consumption of the battery, which is the power source of the mobile electronic apparatus, and to realize a mobile electronic apparatus capable of operating for a long period per charge.

In the mobile electronic apparatus, the display device may be a dot matrix type liquid crystal display device. This serves to further reduce the consumption of the battery and to extend the duration of operation.

In the mobile electronic apparatus, the display control device may be provided with a segment drive means for generating signals for driving segment electrodes of the liquid crystal display device, and a common electrode drive circuit for generating a signal for driving common electrodes of the liquid crystal display device is configured as a semiconductor integrated circuit over a separate semiconductor chip from the semiconductor chip over which the display control device is formed, wherein the common electrode drive circuit is configured of an element higher in withstand voltage than the elements constituting the display control device. This enables only the common electrode drive circuit requiring a high withstand voltage to be configured of another chip, making it possible to enhance the performance compared with a configuration in which segment drive means and the common electrode drive circuit are formed over the same chip, to simplify the process and to reduce the manufacturing cost.

### BRIEF DESCRIPTION OF THE DRAWINGS

FIGS. 1A and 1B are block diagrams illustrating the overall configuration of a mobile telephone provided with a liquid crystal control driver to which the present invention is applied.

FIG. 2 is a block diagram showing details of the liquid crystal control driver embodying the invention.

FIG. 3 is a circuit diagram illustrating a specific example of write data latch circuit of a display RAM in the liquid crystal control driver.

FIG. 4 is a circuit diagram illustrating a more specific example of memory array and write data latch circuit.

FIGS. 5A and 5B are timing charts showing the waveforms of the latch timing signal in the display control driver embodying the invention in the mode of collective writing and in the mode of consecutive writing into the display RAM.

FIGS. 6A and 6B are diagrams showing the relationships between each word (16-bit data) and the address in writing data into the display RAM in the collective writing mode in a system using the liquid crystal control driver embodying the invention.

FIGS. 7A to 7C are diagrams showing the relationships between the data size, the number of times of writing into the latch circuit, and the number of times of writing into the display RAM when data with neat breaks are to be written into the display RAM in the collective writing mode in the system using the liquid crystal control driver embodying the invention.

FIGS. 8A to 8C are diagrams showing the relationships between the data size, the number of times of writing into the latch circuit, and the number of times of writing into the display RAM when data with awkward breaks are to be written into the display RAM in the collective writing mode in the system using the liquid crystal control driver embodying the invention.

FIGS. 9A to 9C are diagrams showing an example of configuration of a mask register for setting the number of bits of data to be transferred to the bit lines of the display RAM, the relationship between the setpoint of the register, and examples of setpoints in the register.

FIGS. 10A to 10D are waveform diagrams of the latch timing signals when setting is done into the mask register.

FIG. 11 is a circuit diagram of an example of configuration of the latch circuit for latching write data into a display memory in a conventional liquid crystal controller driver.

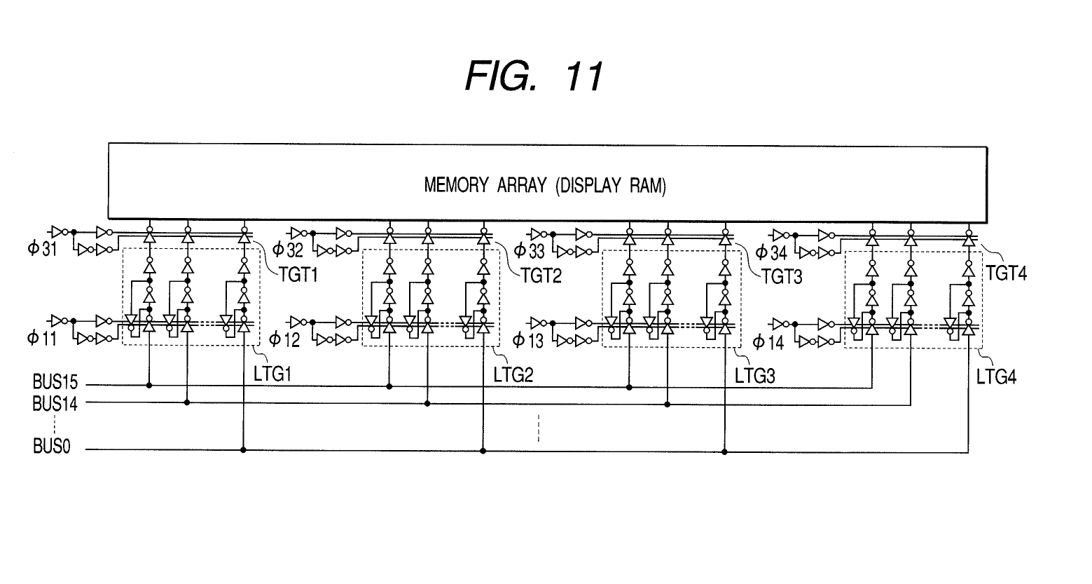

FIG. 12 is a timing chart showing an example of the timing of latching data into the display memory in the conventional liquid crystal controller driver and the timing of writing data into the display memory.

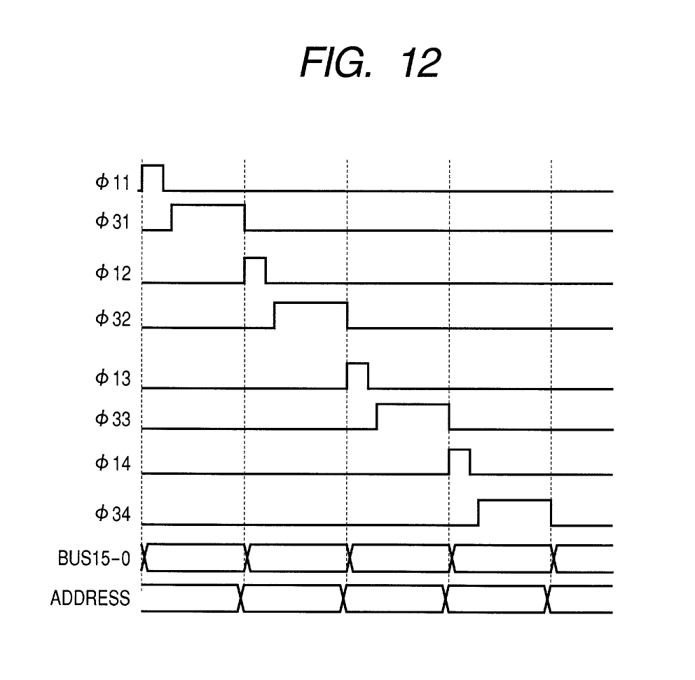

### DETAILED DESCRIPTION OF THE PREFERRED EMBODIMENT

A preferred embodiment of the present invention will be described below with reference to drawings.

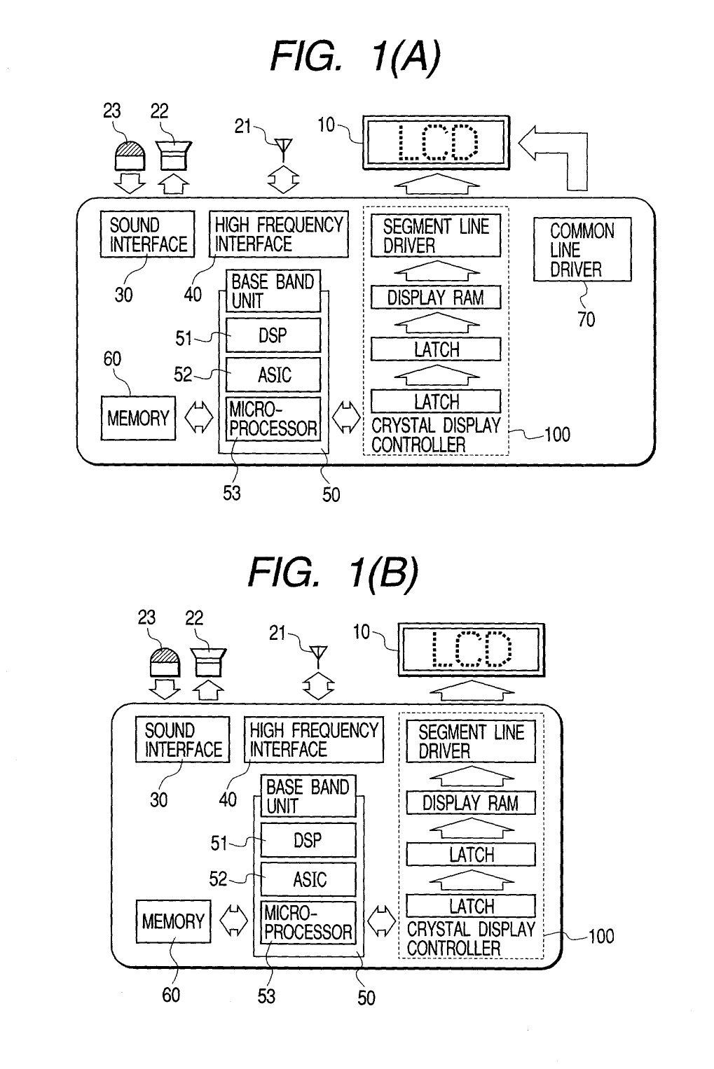

FIG. 1(A) is a block diagram illustrating the overall configuration of a mobile telephone provided with a liquid crystal control driver, which is a first preferred embodiment of a display control device according to the invention.

The mobile telephone using this embodiment of the invention is provided with a liquid crystal panel 10 as the display unit, an antenna 21 for use in transmission and reception, a loudspeaker 22 for sound outputting, a microphone 23 for sound inputting, a liquid crystal control driver 100 as the display control device pertaining to the invention, a sound interface 30 for inputting and outputting signals to and out of the microphone 23 and the loudspeaker 22, respectively, a high frequency interface 40 for inputting and outputting signals to and from the antenna 21, a digital signal processor (DSP) 51 for processing sound signals and transmit/receive signals, an application specific integrated circuits (ASIC) 52 for providing customized functions (user logic), a microprocessor 53 as the data processing unit for overall control, including display control, of the apparatus, and a memory 60 for storing data. The DSP 51, ASIC 52 and the microprocessor 53 constitute a so-called baseband unit 50.

The liquid crystal panel 10 may be, though not particularly limited to, a dot matrix type panel in which display picture elements, for instance 176×128, are arranged in a matrix. Where the liquid crystal panel is for color displaying, each picture element consists of three dots, that is, red, blue, and green. The memory 60, consisting of for instance a flash memory or the like permitting deletion block by block, the block having a prescribed size, stores a control program and control data for the whole mobile telephone system including display control, and also has the function of a character generator read only memory (CGROM), which is a pattern memory storing display data including character fonts as two-dimensional display patterns.

Further in the system of this configuration, a segment driver for driving (e.g. 384) segment electrodes of the liquid crystal panel 10 is built into the liquid crystal control driver 100, and a common driver 70 for driving (e.g. 176) common electrodes of the liquid crystal panel 10 is configured over another semiconductor chip. However, this configuration is not absolutely required, but the liquid crystal control driver 100 may have both a segment driver and a common driver built into it as illustrated in FIG. 1(B) for example.

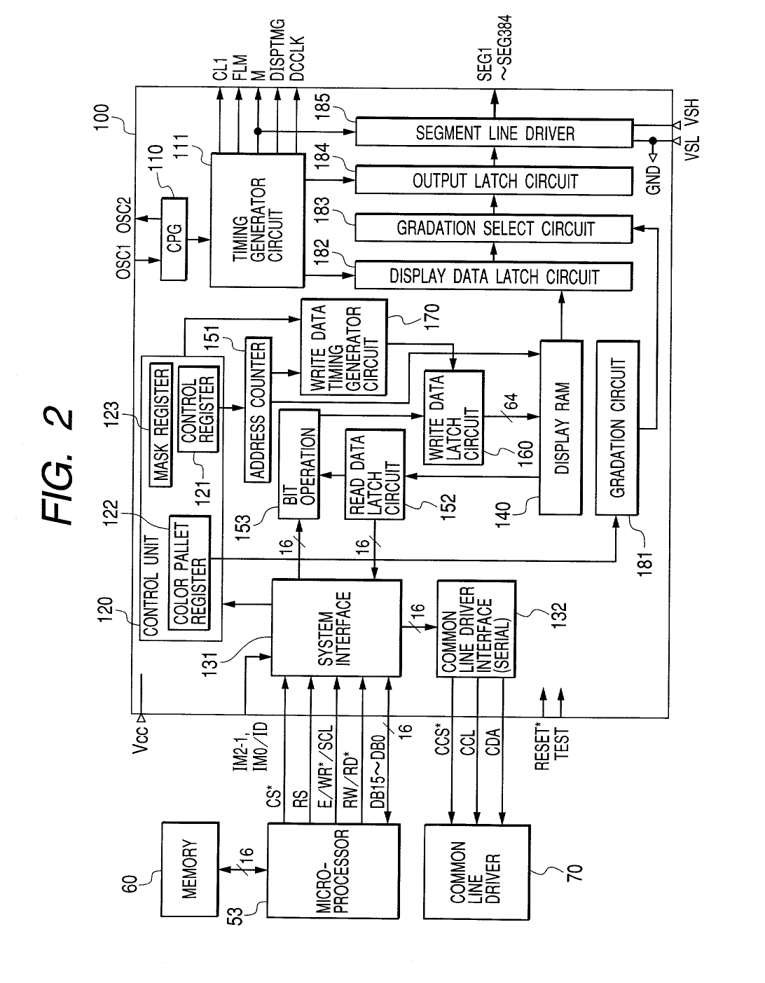

FIG. 2 is a block diagram showing an example of liquid crystal control driver 100 having the configuration of FIG. 1(A).

This example of liquid crystal control driver 100 is provided with a pulse generator 110 for generating a reference clock pulse within the chip on the basis of an oscillation signal from an external source or an oscillation signal from an oscillator connected to an external terminal, a timing generator 111 for generating a timing control signal within the chip on the basis of this clock pulse, a control unit 120 for controlling the whole chip inside in accordance with an instruction from the external microprocessor 53, a system interface 131 for transmitting and receiving data to and from the microprocessor 53, a common driver interface 132 for supplying the external common driver chip 70 with a control signal CS, a clock signal CCL, a command CDM and so forth, and a display random access memory (RAM) 140 as a display memory for storing display data in a bit map system. The display RAM is configured of 176 word lines×1024 bits for instance, and operates at a speed of about 2 MHz.

In this example of liquid crystal control driver 100, there are also provided an address counter 151 for generating addresses for the display RAM 140; a read data latch circuit 152 for holding data read out of the display RAM 140; a bit operation circuit 153, equipped with a logical operation means for performing logical operations for watermark displaying and superposed displaying on the basis of data read out to the read data latch circuit 152, i.e. already displayed contents, and new display data supplied from the microprocessor 53 and a bit shift means for scroll displaying, for performing bit processing on write data from the microprocessor 53 or read data from the display RAM 140; a write data latch circuit 160 for taking in data having undergone bit processing and writing data into the display RAM 140; and a write timing generator 170 for generating a timing signal for the write data latch circuit 160 on the basis of signals from the control unit 120 and the address counter 151. Where neither for watermark displaying nor superposed displaying is needed, data supplied from the microprocessor 53 just pass the bit operation circuit 153 and are transmitted to the write data latch circuit 160. Incidentally, the speed of data writing from the microprocessor 53 into the write data latch circuit 160 is set to be about 10 MHz, for instance.

This example of liquid crystal control driver 100 is further provided with a PWM gradation circuit 181 for generating waveform signals suitable for color displaying and gradation displaying; a display data latch circuit 182 for holding display data read out of the display RAM 140 for displaying on the liquid crystal panel; a gradation control circuit 183 for selecting a waveform signal suitable for the display data out of the waveform signals supplied from the PWM gradation circuit 181 on the basis of the display data held by the display data latch circuit 182; an output latch circuit 184 for holding the selected gradation data; and a segment driver 185 for outputting segment drive signals SEG1 through SEG384 to be applied to the segment electrodes of the liquid crystal panel 10 on the basis of the data latched by the output latch circuit 184.

This segment driver 185 is configured to be able to accept the application of a liquid crystal drive voltage VS supplied from the common driver chip 70. This configuration to allow the supply of the liquid crystal drive voltage VS from outside enables this example of liquid crystal control driver 100 to dispense with an internal power supply circuit, and this makes it possible to configure the whole chip circuitry of an element of a lower withstand voltage (MOSFET) than where a power supply circuit is built in. On the other hand, the common driver chip 70 is configured of an element relatively high in withstand voltage. If the segment driver and the common driver were formed over the same chip, a process to form an element of a higher withstand voltage and another process to form an element of a lower withstand voltage would be required to complicate the whole process, but the use of different chips serves to simplify the process.

The control unit 120 is provided with registers including a control register 121 for controlling the operating state of the whole chip including the operating mode of this liquid crystal control driver 100, a color palette register 122 in which are stored data for color displaying, and a mask register 123 for storing mask data for prohibiting the writing of some data when data are to be written into the display RAM 140. The control unit 120 can be controlled in any suitable manner, for instance by generating, upon receiving a command code from the microprocessor 53, a control signal by decoding this command or by providing in advance in the control unit a plurality of command codes and a register for designating the command to be executed (known as an index register) and generating a control signal by having the microprocessor 53 write into the index register to designate the command to be executed.

Under the control of the control unit 120 configured as described above, the liquid crystal control driver 100, when performing display on the liquid crystal panel 10 on the basis of an instruction and data from the microprocessor 53, processes drawing by successively writing display data into the display RAM 140, while performing read processing to read display data successively from the display RAM 140 to form signals to be applied to, and to drive, the segment electrodes of the liquid crystal panel 10.

The system interface 131 transmits and receives to and from the microprocessor 53 data to be written into the registers needed when drawing onto the display RAM and signals including display data. Between the microprocessor 53 and the system interface 131, there are provided control signal lines over which are transmitted a chip select signal CS* for selecting the chip to which data are to be transmitted, a register select signal RS for selecting the register into which the data are to be stored and read/write control signals including E/WR*/SCL and RW/RD*, and data signal lines over which are transmitted 16-bit data signals DB0 through DB15 including register setting data and display data.

E/WR*/SCL and RW/RD* are made available as read/write control signals to ensure compatibility with three kinds of inputs/outputs including those to and from 68-type MPUs, Z80-type MPUs and serial clock synchronism. More specifically, the control signals RS, E and RW are compatible with 68-type MPUs, WR* and RD*, with Z80-type MPUs, and SCL, for inputting/outputting in synchronism with a serial clock. Signals whose signs are marked with * are signals whose effective level is the low level.

The timing generator 111 has functions to generate and supply, in addition to timing signals for the read data latch circuit 182, the latch circuit 184 for holding gradation data and the segment driver 185, various timing signals CL1, FLM, M, DISPTMG and DCCLK to the external common driver chip to achieve synchronism with the drive of the segment electrodes.

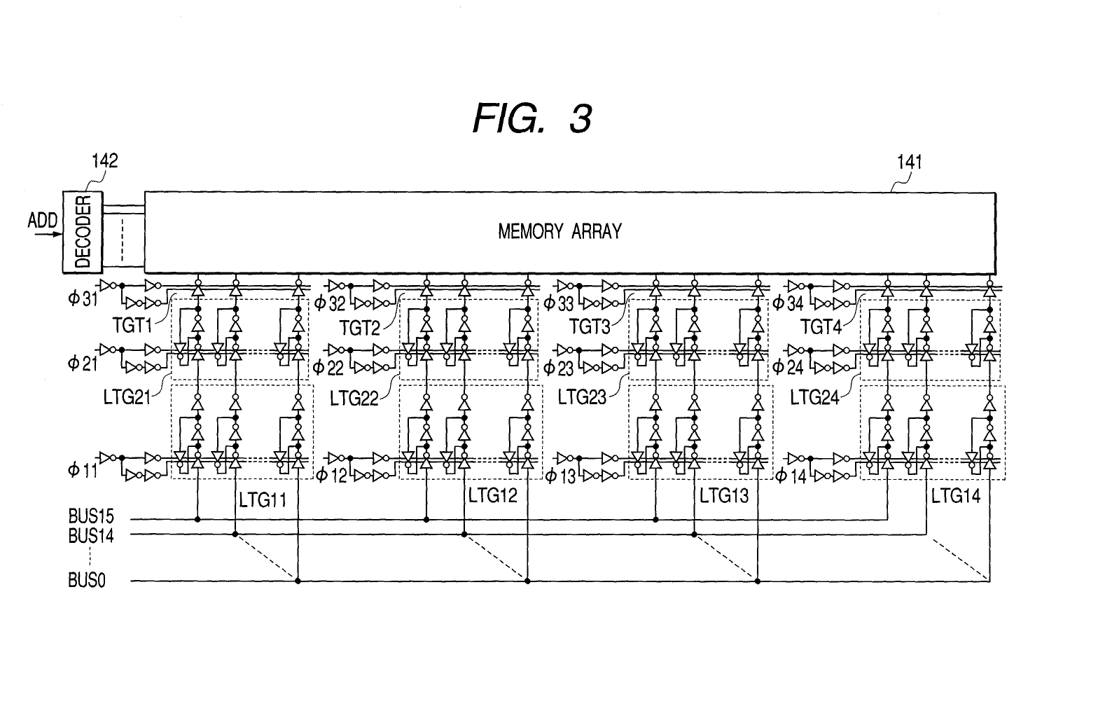

FIG. 3 illustrating a specific example of circuitry for the write data latch circuit 160.

This example of write data latch circuit 160 is configured of first latch groups LTG11 through LTG14 consisting of 16 latch circuits connected to 16-bit data bus signal lines BUS0 through BUS15 and each capable of latching 16-bit data at the same time, second latch groups LTG21 through LTG24 provided between the first latch groups LTG11 through LTG14 and the memory array 141 of the display RAM 140 and consisting of the same number of latch circuits as the first latch groups, and transfer gate groups TGT1 through TGT4 provided on the output terminal side of the second latch groups LTG21 through LTG24. Incidentally, not all the latch circuits provided in the write data latch circuit 160 are shown in FIG. 3, but there are provided altogether 16 units, each unit configured as shown in FIG. 3. Thus there are provided first and second latch groups for (16 bits×4)×16 units=1024 bits. Incidentally, in color displaying, gradation control of one picture element (three dots of red, blue and green) is accomplished with, for example, eight-bit data.

This example of write data latch circuit 160 is controlled with timing signals φ11 through φ14, φ21 through φ24 and φ31 through φ34 supplied from the write timing generator 170. The write timing generator 170 generating the timing signals φ11 through φ14, φ21 through φ24 and φ31 through φ34 are configured so as to generate timing signals φ11 through φ14, φ21 through φ24 and φ31 through φ34 differing between the consecutive writing mode and the collective writing mode, as according to the prior art, in accordance with the setpoint of the control register 121 in the control unit 120.

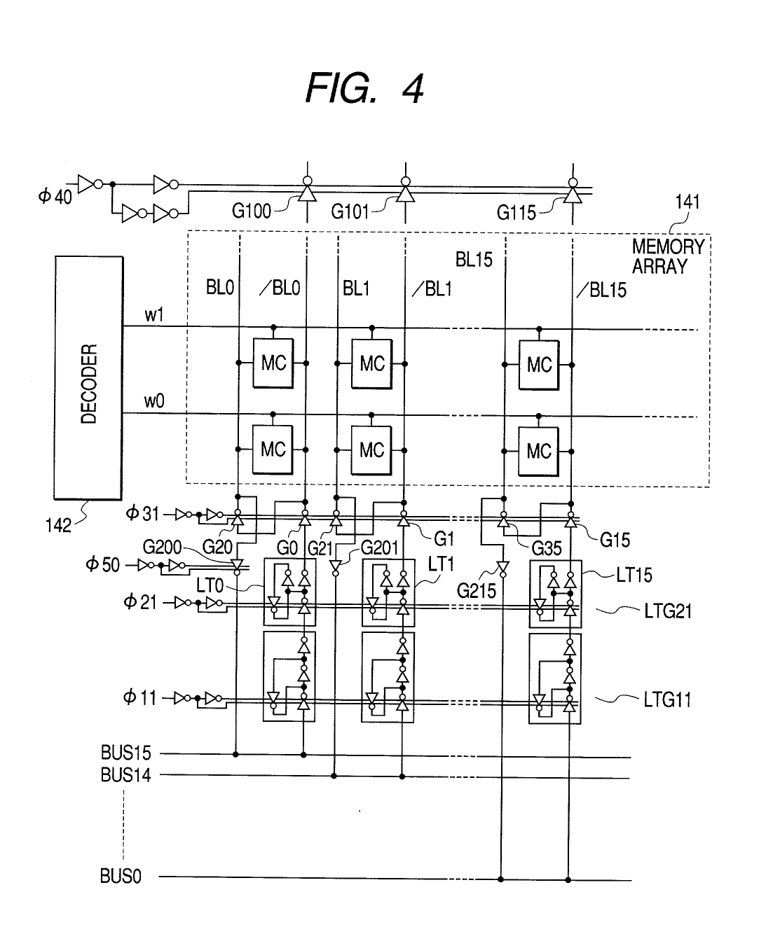

FIG. 4 illustrates a specific example of memory array 141 and transfer gate groups TGT. In the memory array 141, a plurality of word lines W0, W1 . . . and complementary bit lines BL0, /BL0; BL1, /BL1 . . . are arranged in mutually crossing directions, and a memory cell MC is arranged in each of the boxes formed by the word lines W0, W1 . . . and the complementary bit lines BL0, /BL0; BL1, /BL1 . . . The memory cells MC are static memory cells of the known six-element type, and a pair of input/output terminals of each memory cell MC are connected to one of the complementary bit lines BL0, /BL0; BL1, /BL1 . . . ; BL15 /BL15, and the selection terminal of each memory cell MC is connected to one of the word lines W0, W1 . . . .

The transfer gate group TGT consists of first clocked inverters G0, G1 . . . G15 of which the input terminals are connected to the output terminals of latch circuits LT0, LT1 . . . LT15 constituting the second latch groups LTG21 through LTG24 and the output terminals are connected to either of the complementary bit lines BLi and /BLi (i=0 through 15) (e.g. /BLi) and second clocked inverters G20, G21 . . . G35 of which the inputs are the outputs of the inverters G0, G1 . . . G15 and the output terminals are connected to either of the complementary bit lines BLi and /BLi (i=0 through 15) (e.g. BLi).

The clocked inverters G0, G1 . . . G15, G20, G21 . . . G35 connected to BLi of these complementary bit lines BLi and /BLi (i=0 through 15) are so configured that they are controlled with the same timing control signal φ31; transmit the output signals of the latch circuits LT1, LT2 . . . LT16 to the complementary bit lines BL0, /BL0; BL1, /BL1 . . . ; BL15 /BL15 when the gate is opened, and write into the memory cells MC connected to the word line then placed at the selection level.

To the other ends of /BL0, /BL1, . . . /BL15 out of the complementary bit lines BL0, /BL0; BL1, /BL1 . . . ; BL15 and /BL15 are connected the input terminals of the clocked inverters G100, G101 . . . G115 for display read use. The configuration is such that control is accomplished with a timing control signal φ40 and, when the gate is opened, the levels of the bit lines /BL0, /BL1 . . . /BL15 are detected, and read data from the memory cells MC connected to the word line then placed at the selection level are outputted. These read data are transferred to the display data latch circuit 182 shown in FIG. 2. The bit lines to which the clocked inverters G100, G101 . . . G115 for display read use may as well be BL0, BL1 . . . BL15.

To the leading edges of BL0, BL1, . . . BL15 out of the complementary bit lines BL0, /BL0; BL1, /BL1 . . . ; BL15 and /BL15 are connected the clocked inverters G200, G201 . . . G215 for operational read use which, controlled with a timing control signal φ50, detect the levels of the complementary bit lines BL0, BL1 . . . BL15 when the gate is opened, and output read data from the memory cells MC connected to the word line then placed at the selection level. These read data are transferred to the read data latch circuit 152 shown in FIG. 2. The bit lines to which the clocked inverters G200, G201 . . . G215 may as well be /BL0, /BL1 . . . /BL15.

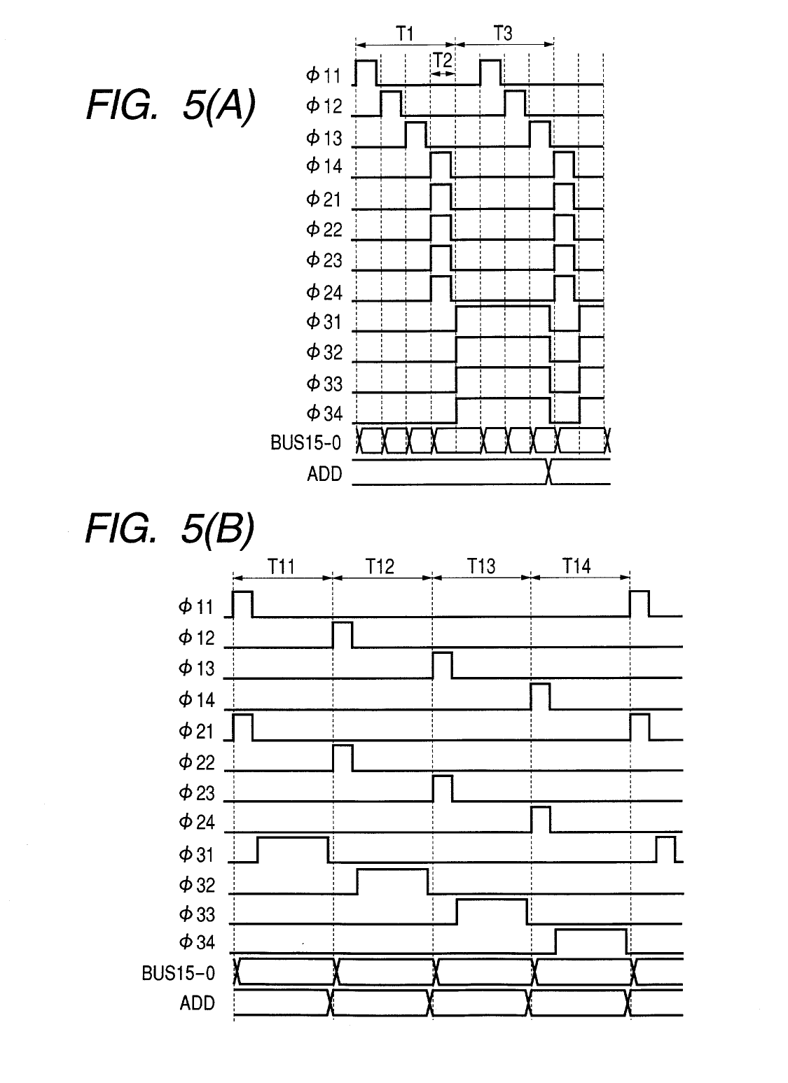

FIG. 5(A) shows the waveforms of the timing signals φ11 through φ14, φ21 through φ24 and φ31 through φ34 where the mode of writing into the display RAM 140 in this example of display control driver is the collective writing mode.

In this collective writing mode, first signals on the data bus BUS0 through BUS15 are successively taken into the first latch groups LTG11 through LTG14, 16 bits at a time, in accordance with the timing signals φ11 through φ14 (period T1). At the same time as the final 16 bits, i.e. data of the fourth word, are taken into LTG14, data of four words latched by the first latch groups LTG11 through LTG14 are taken into the second latch groups LTG11 through LTG14 in accordance with the timing signals φ21 through φ24 (period T1).

After that, the transfer gate groups TGT1 through TGT4 are opened at the same time in accordance with the timing signals φ31 through φ34. Four words of data latched by the second latch groups LTG21 through LTG24 are transferred to bit lines on of the memory array 141 of the display RAM and, as an address ADD from the address counter 151 is decoded by a decoder (DEC) 142, the transferred data are written into the memory cells MC connected to the word line then placed at the selection level (period T3). During this writing of data into the memory array, the next data are taken into the first latch groups LTG11 through LTG14.

FIG. 5(B) shows the waveforms of the timing signals φ11 through φ14, φ21 through φ24, φ31 through φ34 in the consecutive writing mode.

In this consecutive writing mode, the signals φ11 through φ14 and φ21 through φ24 are treated as signals of the same timing. First, 16-bit signals on the data bus BUS0 through BUS15 are taken into the first latch group LTG11 of the first latch groups in accordance with the timing signal φ11, and at the same time the same data are taken in as they are into the second latch groups LTG21 in accordance with the timing signal φ21. Then, the transfer gate group TGT1 is opened in accordance with the timing signal φ31, and data of one word latched by the second latch group LTG21 are transferred over the bit line matching the memory array of the display RAM 140 to accomplish writing into memory cells (period T11).

Then, 16-bit signals on the data bus BUS0 through BUS15 are taken into the second latch group LTG12 of the first latch groups in accordance with the timing signal φ12, and at the same time the same data are taken into the second latch groups LTG22 as they are in accordance with the timing signal φ22. After that, the transfer gate groups TGT2 is opened in accordance with the timing signal φ32, and data of one word latched by the second latch groups LTG22 are transferred over the bit line matching the memory array of the display RAM 140 to accomplish writing into memory cells (period T12).

In this way, 16-bit signals on the data bus BUS0 through BUS15 are successively written into the memory array. However, in this consecutive writing mode, it is no need to cause the first latch groups LTG11 through LTG14 to take in and write data in this sequence, but this can be done in any desired sequence, such as LTG12, LTG14, LTG13, LTG11 . . . for instance.

As is evident from the comparison of FIGS. 5(A) and 5(B), the use of the collective writing mode serves not only to shorten the length of time required for writing but also to save power consumption. In the consecutive writing mode, more power is consumed because every time data of one word are written a word line has to be actuated even if memory cells are connected to the same word, but in the collective writing mode a word line needs to be actuated only once, with a corresponding saving in power consumption, because data of four words can be written at the same into memory cells connected to the same word. In other words, the use of the collective writing mode allows the number of times of data writing into the memory array to be reduced even if data are taken into latch circuits at higher speed, so that in the consecutive writing mode four times as large a quantity of data can be written per word of data without increasing the length of time required for writing or power consumption.

While in this embodiment of the invention data of four words are successively taken into the latch circuits and collectively written into the memory array, it is also possible to use a configuration in which data of five or more words are collectively written into the memory array after they are taken into latch circuits successively. However, if the quantity of data to be collectively written is increased excessively, even where part of data in the display RAM 140, data of only one word, for example, are to be rewritten, data equivalent to a plurality of words will have to be sent to the latch circuits, resulting in an increased load on the microprocessor and, if writing into non-consecutive addresses takes place, in an increase in overhead as well.

Therefore, the quantity of data to be written collectively should be determined according to the data write size which takes place in the system relatively frequently. The system of this embodiment of the invention is configured for collective writing of four words of data.

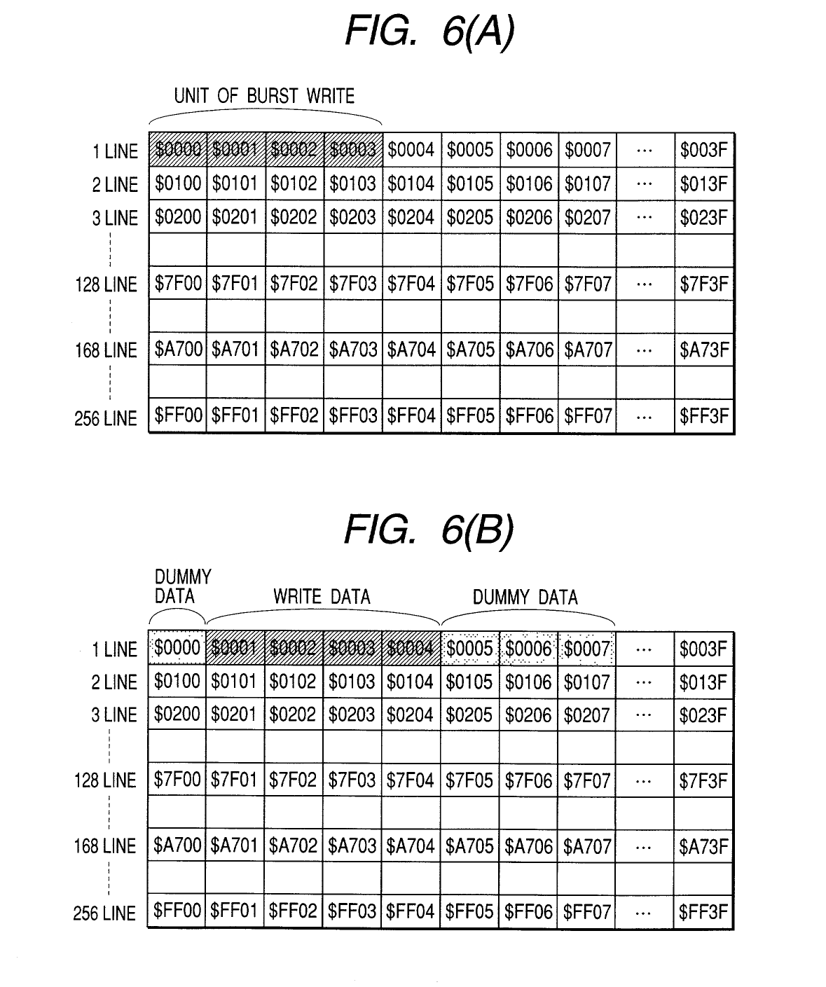

FIG. 6(A) shows the relationship between each word (16-bit data) and the address in writing data into all the memory cells in the display RAM 140, for instance, in a system using the liquid crystal control driver 100 embodying the invention in this way. In this chart, addresses “0000” through “003F” on line 1 represent the addresses of data of 1024 bits (64 words) equivalent to one line on the liquid crystal panel 10, and these one line equivalent of data are stored, though not absolutely should be, in 1024 memory cells connected to one word line of the display RAM 140.

The data in the shaded part of FIG. 6(A) are data of four words having addresses “0000” through “0003”, and these data of four words are supplied, in the collective writing mode, word by word from an external microprocessor and successively written into the first latch groups LTG11 through LTG14. When all the four words are ready, the data are transferred to the second latch groups LTG21 through LTG24 and written into memory cells matching addresses “0000” through “0003” in the display RAM 140.

In parallel with the start of writing these data of four words, the data of four words of next addresses “0004” through “0007” are supplied word by word from the external microprocessor, successively written into the first latch groups LTG11 through LTG14, transferred to the second latch groups LTG21 through LTG24 when all the four words are ready, and written into matching memory cells in the display RAM 140. By repeating the operation described above, data can be written efficiently in a short period of time. In addition, the number of accesses to the display RAM 140 (actions to actuate word lines) can be fewer than when data are written word by word, with a corresponding saving in power consumption.

FIG. 6(B) shows the relationship between write data from the microprocessor where data of some of the addresses in the display RAM 140 are to be rewritten in the collective writing mode in a system using the liquid crystal control driver 100 of this embodiment and data transferred from the first latch groups LTG11 through LTG14 to the display RAM 140. Out of the data of eight words of addresses “0000” through “0007” in the shaded part of FIG. 6(A), data of four words from“0001” through “0004” are supposed to be write data actually desired to be rewritten.

In this case, the microprocessor adds dummy data of one word of address “0000” and dummy data of three words of addresses “0005” through “0007”. First, data of four words of addresses “0000” through “0004” including the dummy data are successively supplied to and written into the first latch groups LTG11 through LTG14 word by word. When all the four words are ready, data of three words of them, excluding the dummy data, are transferred to the second latch groups LTG21 through LTG24 and written into matching memory cells in the display RAM 140.

In parallel with the start of writing these data of four words, the data of four words of next addresses “0004” through “0007” including the three words of dummy data, are supplied word by word from the external microprocessor, successively written into the first latch groups LTG11 through LTGl4, transferred to the second latch groups LTG21 through LTG24 when all the four words are ready, and written into matching memory cells in the display RAM 140. Incidentally, the configuration is such that the consecutive addresses used in writing are automatically generated by the setting of the leading address of the write position in the address counter 151 by the external microprocessor and counting up by the address counter 151.

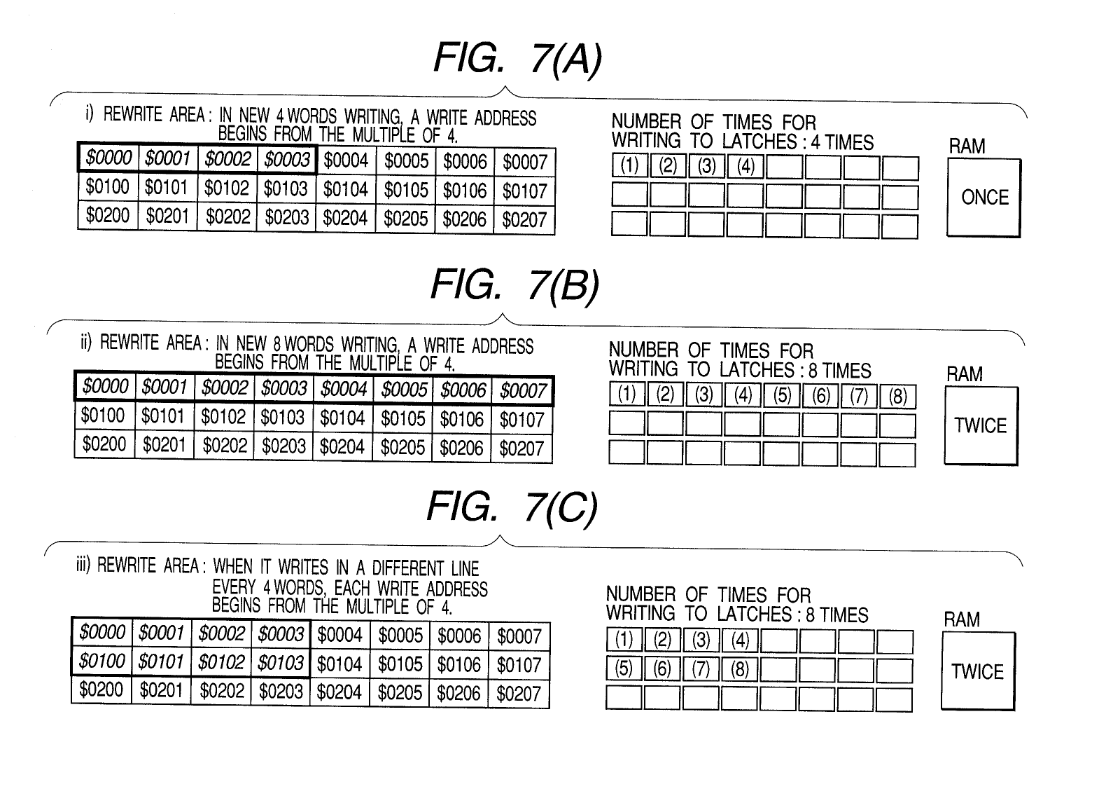

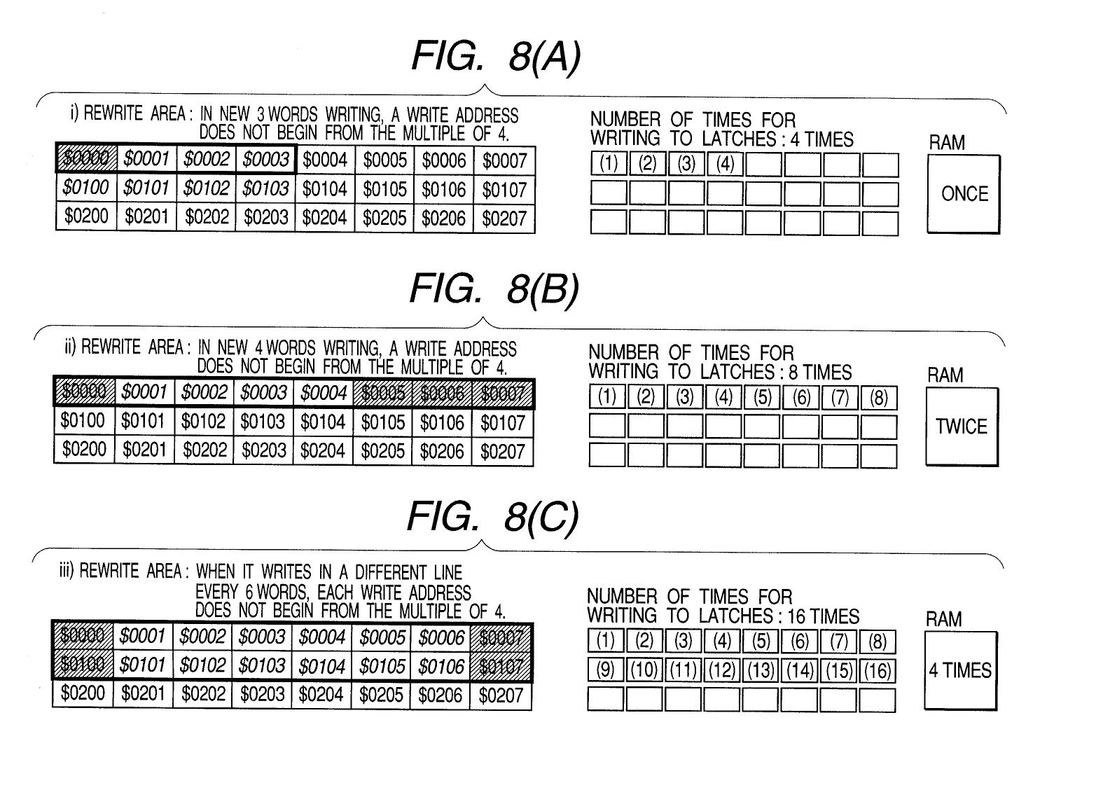

FIG. 7 and FIG. 8 show the relationships between the address range of data to be rewritten and the number of times of data writing into the first latch groups LTG11 through LTG14. In the drawings, the addresses surrounded by bold lines denote the data to be rewritten. Of these drawings, FIG. 7 shows addresses of data to be written having neat breaks, and FIG. 8, addresses each spanning two or more out of groups of four words each.

As is seen from FIG. 7 and FIG. 8, where the address of data to be rewritten spans two or more out of groups of four words each as shown in FIG. 8, the number of times of writing is greater by the number of words of dummy data than an address having neat breaks at every fourth word as shown in FIG. 7, and the number of writing into the display RAM 140 is correspondingly greater, but the number of data writing into the display RAM is smaller than in the mode of writing one word at a time, resulting in a corresponding reduction in power consumption.

Next will described a configuration for addresses data to be rewritten spanning two or more groups of four words each as shown in FIG. 8(B), out of the data of four words including dummy data written into the first latch groups LTG11 through LTG14, only the non-dummy data can be transferred to the second latch groups LTG21 through LTG24 and written into matching memory cells into the display RAM 140.

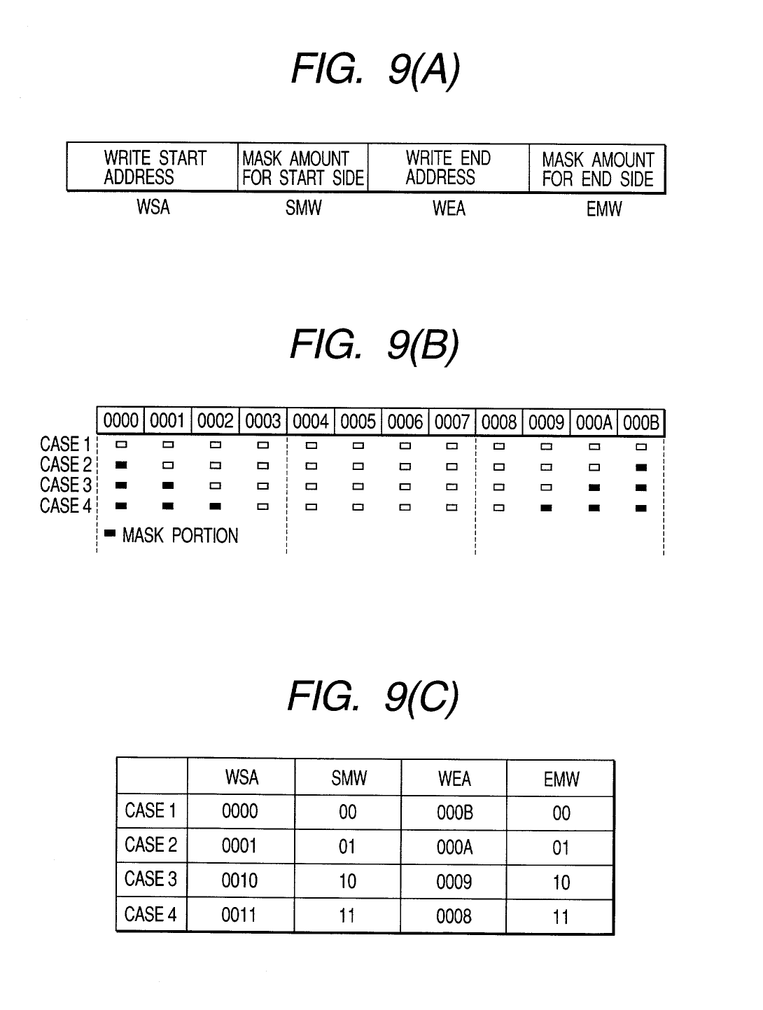

Such selective data writing is made possible by setting into the mask register 123 provided in the control unit 120 as described above. More specifically, in the mask register 122 are set a write start address setting field WSA, a mask amount for start side setting field SMW in which to set the number of words from the start of masking, a write end address setting field WEA, and a mask amount for end side setting field EMW in which to set the number of words back from the end of masking, as shown in FIG. 9(A). Incidentally, two bits each are sufficient for the mask amount for start side setting field SMW and the mask amount for end side setting field EMW because the unit of collecting writing is four words in this embodiment. The mask amount, as it is automatically determined by the write start address and the write end address, need not be set by the microprocessor 53. Where the unit of collective writing is eight words, three bits each can be assigned to the mask amount for start side setting field SMW and the mask amount for end side setting field EMW.

Then, when the external microprocessor 53 starts writing data into the first latch groups LTG11 through LTG14 after setting into this mask register 123 the timings signal φ31 through φ34 . . . which transfer only non-dummy data from the write timing generator 170 to the transfer gate means TGT1 through TGT4 . . . shown in FIG. 3 when transferring data from the first latch groups LTG11 through LTG14 to the display RAM 140 after the completion of data writing.

Specific data masking by setting into this mask register 123 will now be described with reference to four cases of writing data of 6 to 12 words as shown in FIG. 9(B) by way of example.

In FIG. 9(B), the relationships between the data to be masked (dummy data) and data to be written into the display RAM are shown: in the first case in data of 12 words are written into addresses “0000” through “000B” having neat breaks; in the second case, data of 10 words are written into intermediate addresses “0001” through “000A”; in the third case, data of eight words are written into intermediate addresses “0002” through “0009”; and in the fourth case, data of six words are written into addresses “0003” through “0008”.

In FIG. 9(B), blank boxes (□ marks) signify data to be written, and blank boxes (▪ marks), data to be masked. In both cases, data to be written from the external microprocessor into the first latch groups LTG11 through LTG14 are data of 12 words. FIG. 9(C) shows values to be set into the mask register 122 to match cases 1 through 4. The end address may as well be the leading address “0008” of the final group instead of “000B”.

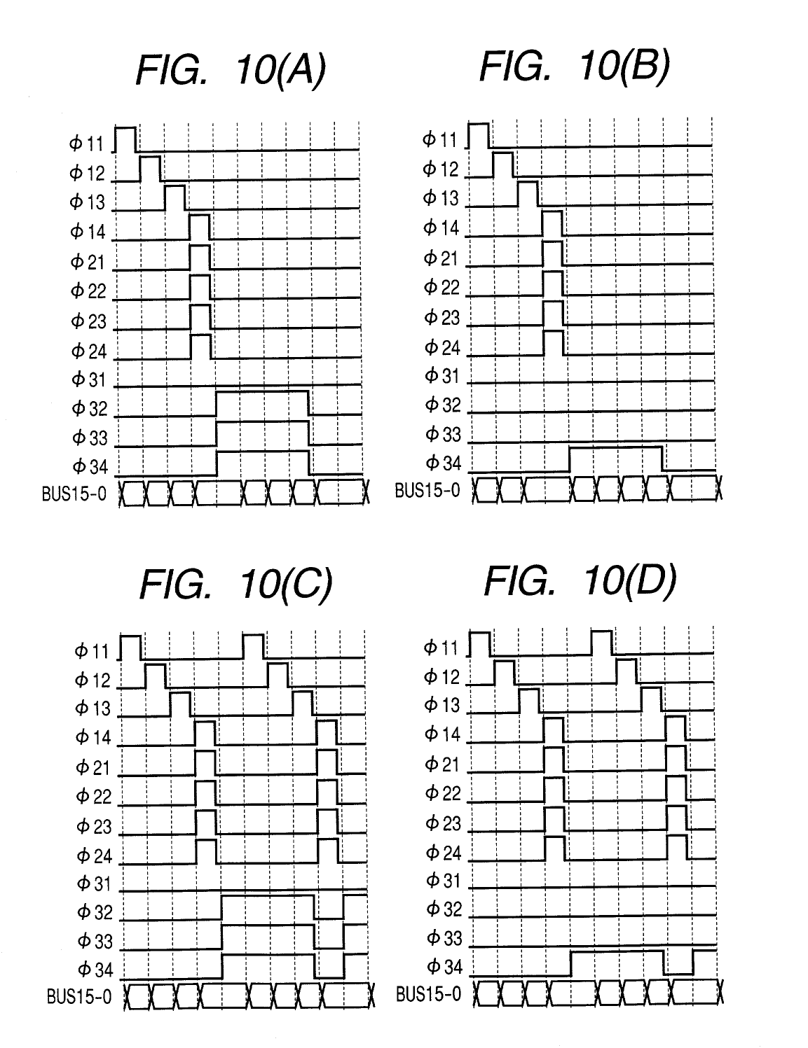

FIG. 10(A) shows waveforms of timing signals φ11 through φ14, φ21 through φ24 and φ31 through φ34 supplied to matching ones in the first latch groups LTG11 through LTG14, the second latch groups LTG21 through LTG24 and the transfer gate groups TGT11 through TGT14, when data of 10 words for addresses “0001” through “000A” of case 2 are to be written into the display RAM 140, the data of addresses “0000” through “0003”.

Further, FIG. 10(B) shows waveforms of timing signals φ11 through φ14, φ21 through φ24 and φ31 through φ34 supplied to matching ones in the first latch groups LTG11 through LTG14, the second latch groups LTG21 through LTG24 and the transfer gate groups TGT11 through TGT14, when data of eight words for addresses “0003” through “0008” of case 4 are to be written into the display RAM 140, the data of addresses “0000” through “0003”.

The invention by the present inventor has been specifically described above with reference to an embodiment thereof, but obviously the present invention is not limited to the foregoing embodiment, and can be modified in various ways without deviating from the essentials thereof.

For instance, while in the embodiment the first latch groups LTG11 through LTG14, the second latch groups LTG21 through LTG24 and the transfer gate groups TGT1 through TGT4 are provided between the buses BUS0 through BUS15 and the memory array 141, it is also possible to dispense with the second latch groups LTG21 through LTG24 and have the data held by the first latch groups LTG11 through LTG14 transferred by the transfer gate groups TGT1 through TGT4 to the bit lines of the memory array 141. In this configuration, 64 bits can be collectively written as described above.

However, where the first latch groups LTG11 through LTG14 and the second latch groups LTG21 through LTG24 are provided as in this embodiment, if data have to be consecutively written into memory cells on the same bit line as in FIG. 7(C), it is possible, while the data first taken in are transferred and written into the memory array as in FIGS. 10(C) and 10(D), to take in the next data into the first latch groups LTG11 through LTG14 in parallel. In this case, too, it is possible to prevent the first one of the four words taken into the first latch groups LTG11 through LTG14 according to the setpoint in the mask register from being transferred to the memory array.

Although the foregoing description of the invention by the present inventor mainly referred to the display device for mobile telephones, which constitutes a field of application constituting the background of the invention, the invention is not limited to this application, but can also be applied to various portable electronic devices including personal handy phones (PHS), Pocket Bells and pagers. The invention can be applied not only to portable electronic devices and liquid crystal display units but also extensively to, for instance, display devices and their control units in large equipment and dot display devices in which LEDs or the like are two-dimensionally arrayed.

What follows is a brief summary of a typical aspect of the present invention disclosed in this application.

Thus, according to the invention, it is possible to realize a display control device capable of writing data into an internal display RAM at high speed without increasing power consumption and a mobile electronic apparatus mounted therewith.

What is claimed is:

1. A display control device comprising:
a display memory which is capable of storing display data for a display device and into which display data are written in a prescribed number of bits at a time, the display control device successively reading the display data out of the display memory and forming and supplying a drive signal to the display device,
wherein said display memory includes:
a memory array provided with a plurality of memory cells arranged in a matrix form,
a plurality of word lines to which selection terminals for the memory cells are connected,
a plurality of bit lines which are arranged in a direction to cross the word lines and to which data input/output nodes for the memory cells are connected, and
input transfer means and output transfer means being connected to said bit lines, data transferring by said input transfer means resulting in writing of data into the memory cells connected to a word line in a selected state, and data transferring by said output transfer means resulting in reading of data out of the memory cells connected to the word line in a selected state, and
wherein said display memory further includes a plurality of first data latch means capable of successively taking in the display data in said prescribed number of bits at a time, and display data held by the first data latch means can be collectively transferred by said input transfer means to the bit lines of said display memory in a number of bits at a time equal to an integral multiple of (n times) the number of bits of the display data taken into the first data latch means.

2. The display control device according to claim 1, further comprising:
a plurality of second data latch means capable of taking in display data held by said first data latch means in a number of bits at a time equal to an integral multiple of the number of bits of the display data taken into said first data latch means,
wherein said input transfer means are configured to be capable of transferring display data held by the second data latch means to the bit lines of said display memory in a number of bits at a time equal to an integral multiple of (n times) the number of bits of the display data taken into said first data latch means.

3. The display control device according to claim 2, wherein transferring of data by said input transfer means to the bit lines of said display memory takes place at the same timing as the final data taken into said first data latch means.

4. The display control device according to claim 3, wherein the number of said first data latch means is an integral multiple further of said n times.

5. The display control device according to claim 4, further comprising a mask setting means capable of setting the number of bits of data to be transferred by said input transfer means to the bit lines of said display memory, wherein said input transfer means is controlled on the basis of the set information of the mask setting means.

6. The display control device according to claim 5, wherein said mask setting means can set the start address of write data in a range of consecutive addresses and the quantity of data to be masked from that start address and the end address of the same and the quantity of data to be masked from that end address.

7. The display control device according to claim 6, further comprising:
segment drive means for generating signals for driving segment electrodes of an external liquid crystal display device on the basis of display data read out of said display memory,
wherein said display control device is configured as a semiconductor integrated circuit over a single semiconductor chip.

8. A mobile electronic apparatus comprising:
the display control device according to claim 1;
a data processing unit for generating display data to be written into said display memory and setting information on their writing position; and
a display device for carrying out displaying with a display drive signal read out of said display memory and formed by said display control device on the basis of the display data.

9. The mobile electronic apparatus according to claim 8, wherein said display device is a dot matrix type liquid crystal display device.

10. The mobile electronic apparatus according to claim 15,
wherein said display control device comprises a segment drive means for generating signals for driving segment electrodes of said liquid crystal display device, and a common electrode drive circuit for generating a signal for driving common electrodes of said liquid crystal display device is configured as a semiconductor integrated circuit over a separate semiconductor chip from the semiconductor chip over which said display control device is formed, and the common electrode drive circuit is configured of an element higher in withstand voltage than the elements constituting said display control device.

11. A display control device formed over a single semiconductor substrate, comprising:
a memory for storing display data to be displayed on a liquid crystal panel;
a k-bit first external terminal to which display data to be stored in said memory are supplied from a microprocessor;
a plurality of second external terminals for outputting drive signals for driving said liquid crystal panel on the basis of m-bit read data from said memory;
a first latch circuit connected between the input of said memory and said first external terminal and capable of storing m-bit display data; and
a transfer circuit for selecting, for each integral multiple (multiple by n) of said k bits, display data of not more than said m bits (k•n) in said first latch circuit and transferring them to bit lines of said memory.

12. The display control device according to claim 11, further comprising:
a second latch circuit provided between said transfer circuit and said first latch circuit and capable of storing said m-bit display data,
said second latch circuit outputting display data of said number of bits (k•n) to said transfer circuit.

13. The display control device according to claim 11,
wherein said display control device has a control register for setting a first operating mode and a second operating mode,
wherein the mode of writing into said memory is set in said first operating mode in response to the setting of a first value into said control register,
wherein the mode of writing into said memory is set in said second operating mode in response to the setting of a second value into said control register, and
wherein said transfer circuit transfers, for each integral multiple (multiple by n) of said k bits stored in said first latch circuit, said display data to bit lines of said memory in response to setting into said first operating mode and, for every k bits stored in said first latch circuit, said display data to bit lines of said memory in response to setting into said second operating mode.

14. The display control device according to claim 13, further comprising a segment driver for forming a drive signal to be supplied to a segment line of said liquid crystal panel in response to read data from said memory.

15. The display control device according to claim 14, further comprising a gradation voltage generator and a gradation voltage select circuit for selecting, in response to read data from said memory, a desired gradation voltage out of a plurality of gradation voltages generated by said gradation voltage generator.

16. The display control device according to claim 15, further comprising a common driver for forming a drive signal for periodically driving a plurality of common lines of said liquid crystal panel.

17. The display control device according to claim 15, further comprising a mask setting circuit capable of setting the number of bits of data to be supplied to bit lines of said memory,
said transfer circuit being controlled on the basis of information set in said mask setting circuit.

18. A display control device, formed over a single semiconductor substrate, comprising:
a memory for storing display data to be displayed on a liquid crystal panel capable of color displaying;
a k-bit first external terminal to which display data to be stored in said memory are supplied from a microprocessor;
a plurality of second external terminals for outputting drive signals for driving said liquid crystal panel on the basis of m-bit read data from said memory;
a first latch circuit connected between the input of said memory and said first external terminal and capable of storing m-bit display data;
a transfer circuit for selecting, for each integral multiple (multiple by n) of said k bits, display data of not more than said m bits (k•n) in said first latch circuit and transferring them to bit lines of said memory;
a gradation voltage generator;
a gradation voltage select circuit for selecting, in response to read data from said memory, a desired gradation voltage out of a plurality of gradation voltages generated by said gradation voltage generator; and
a segment driver for forming a drive signal to be supplied to a segment line of said liquid crystal panel on the basis of said selected gradation voltage.

19. The display control device according to claim 18, further comprising a common driver for forming a drive signal for periodically driving a plurality of common lines of said liquid crystal panel.

20. The display control device according to claim 18, further comprising a mask setting circuit capable of setting the number of bits of data to be supplied to bit lines of said memory,
said transfer circuit being controlled on the basis of information set in said mask setting circuit.

21. A mobile electronic apparatus comprising:
a liquid crystal panel including a plurality of common electrodes, a plurality of segment electrodes, and a plurality of dots driving by the difference in potential between said plurality of common electrodes and said plurality of segment electrodes;
a data processing unit for generating display data to be displayed on said liquid crystal panel; and
a display control device,
wherein said display control device includes:
a memory for storing display data to be displayed on said liquid crystal panel;
a k-bit first external terminal to which display data to be stored in said memory are supplied from said data processing unit;
a plurality of second external terminals for outputting drive signals for driving said liquid crystal panel on the basis of m-bit read data from said memory;
a first latch circuit connected between the input of said memory and said first external terminal and capable of storing m-bit display data;
a transfer circuit for selecting, for each integral multiple (multiple by n) of said k bits, display data of not more than said m bits (k•n) in said first latch circuit and transferring them to bit lines of said memory;
a gradation voltage generator;
a gradation voltage select circuit for selecting, in response to read data from said memory, a desired gradation voltage out of a plurality of gradation voltages generated by said gradation voltage generator; and
a segment driver for forming a drive signal to be supplied to a segment line of said liquid crystal panel on the basis of said selected gradation voltage.

22. The mobile electronic apparatus according to claim 21, wherein said display control device further comprises a common driver for forming a drive signal for periodically driving a plurality of common lines of said liquid crystal panel.

23. The mobile electronic apparatus according to claim 21, wherein said display control device further comprises a mask setting circuit capable of setting the number of bits of data to be supplied to bit lines of said memory,
said transfer circuit being controlled on the basis of information set in said mask setting circuit.

24. The mobile electronic apparatus according to claim 21, wherein said liquid crystal panel is capable of color displaying in which each picture element comprises three dots of red, green and blue.
